(19) United States
(12) Patent Application Publication
(10) Pub. No.: US 2016/0357301 A1
(43) Pub. Date: Dec. 8, 2016

(54) METHOD AND SYSTEM FOR PERFORMING AN ACTION BASED ON NUMBER OF HOVER EVENTS

(71) Applicant: SAMSUNG ELECTRONICS CO., LTD., Suwon-si (KR)

(72) Inventors: Bhanuprakash PADIRI, Bangalore (IN); Sandeep VANGA, Hyderabad (IN)

(73) Assignee: SAMSUNG ELECTRONICS CO., LTD., Suwon-si (KR)

(21) Appl. No.: 14/733,237

(22) Filed: Jun. 8, 2015

(51) Int. Cl. G06F 3/041; G06F 3/0354

(52) U.S. Cl. CPC G06F 3/0416; G06F 3/03545; G06F 2203/04101

(57) ABSTRACT

A method and system for detecting a hover event are provided. The method for detecting a hover event in an electronic device includes identifying a number of hover events performed with respect to a display of the electronic device, and performing at least one operation based on the identified number of the hover events.

### BACKGROUND

### 1. Field

Methods, apparatuses and systems consistent with exemplary embodiments relate to a touch interface in an electronic device, and more particularly, to methods and systems for performing one or more actions based on detection of a number of hover events in the electronic device.

### 2. Description of Related Art.

To provide a simple and intuitive user interface, techniques for interacting with ubiquitous electronic devices are being developed. Among the techniques, a touch screen interface is widely used because of its ease of use. Numerous types of touch techniques through which a user may actively and efficiently interact with an electronic device may be employed in the touch screen interface. The touch techniques that are most commonly used include capacitive touch sensing. Capacitive touch sensing provides reliability, low power consumption, ease of implementation and capability to handle a multi-touch and a hover input. Capacitive touch sensing may be achieved by measuring a change in self-capacitance or a change in mutual capacitance. Mutual capacitance based touch panels have different patterns of sensor electrodes. When an external conductive object is present, a value of mutual capacitance drops from a normal value. The amount of a change in mutual capacitance may be different at different nodes. The same patterns of sensor electrodes for mutual capacitance sensing may also be used for self-capacitance sensing.

Self-capacitance is formed between any touch object (e.g., a conductive material such as a finger and/or stylus) at a certain height above a touch panel and the sensor electrodes. A sensing circuit measures overlapped capacitance between a sensing line (i.e., sensor electrode) and the touch object. An ambient level of self-capacitance data when the touch object is not present is obtained at each sensing line. When the touch object is positioned in proximity to the touch panel, the self-capacitance data in a corresponding region of the touch panel may be increased from the ambient level. Accordingly, based on a difference in capacitance, i.e., a difference between the ambient level and the increased level of the self-capacitance data, the corresponding region of the touch panel and a height of the touch object may be detected.

However, there exist a number of drawbacks in the above mentioned touch technologies. Firstly, power consumption in an electronic device, which is an important criterion to be considered when designing the electronic device, may substantially increase as the number of electrodes increases. Thus, there is a limitation to the number of electrodes that may be used in the electronic device. A typical pitch between electrodes is about 4-5 mm. Therefore, in a 5″×2.7″ display, 30×17 grids of electrodes at 4 mm pitch may be provided. Also, a size of the touch object may be as small as 2×2 mm. Accordingly, it is possible that the touch object is entirely within an area of an electronic grid. In this case, a touch gesture by the touch object may not be detected. Even in a case of a bigger touch object, the touch gesture may not be accurately detected. In case of self-capacitance sensing, a lesser number of nodes (or electrode) are obtained per frame, and thus an accurate touch detection may be difficult.

Secondly, there may exist unavoidable ambient noise sources which affect quality of capacitance data. To reduce a thickness of the display panel, touch sensors may be placed very close to display driving lines of the display panel. This technology is referred to as on-cell capacitive sensing. In an on-cell capacitive touch panel, a display noise in touch signals may be caused due to cross-coupling between the display driving lines and the touch sensors. Although novel noise removal techniques may be employed to remove the display noise, it is impossible to completely eliminate the display noise. Moreover, there are other various noise sources such as a charger noise, an environmental noise, etc.

Thirdly, in case of self-capacitance sensing, to improve sensitivity of the touch sensor, areas of conductors may be increased by coupling multiple driving and sensing lines together to increase a signal to noise ratio (SNR) and sensitivity of the sensor while a resolution of the display panel may be compromised. Also, when a capability of the touch sensor to detect a touch by the touch object at a higher height is increased, the resolution of the display panel may be compromised (i.e., number of nodes and/or electrodes per frame may be decreased).

Furthermore, in touch based authentication methods, such as a pattern swiping, a number of touch entries which are used for authentication may leave a smudge of the pattern on the touch screen interface and hence vulnerable to hacking, which may lead to misuse or serious data theft of the electronic device. Face locking and fingerprint scanners which are also used as authentication methods need extra hardware and are very expensive. Additionally, users may not want to use fingerprint scanners for authentication purposes on the electronic device due to privacy and fraud issues.

### SUMMARY

One or more exemplary embodiments provide a method and a system for performing an action based on a number of hover events in an electronic device.

According to an aspect of an exemplary embodiment, there is provided a method of detecting a hover event in an electronic device including: identifying a number of hover events performed with respect to a display of the electronic device; and performing at least one operation based on the identified number of the hover events.

The identifying may include estimating a height of a proximity touch with respect to the display of the electronic device; detecting a local maximum and a local minimum for the proximity touch based on the estimated height; and determining the proximity touch as the hover event based on the detected local maximum and local minimum.

The identifying may include detecting a number of at least one touch object that performs the hover events based on an area of the display, the area being covered by each of the at least one touch object; and identifying the number of the hover events based on the number of the at least one touch object.

The performing may include determining a match between at least one of the hover events and pre-stored hover events; and performing the at least one operation in response to determining the match.

The hover events may be performed with respect to a touch sensitive bezel of the display of the electronic device.

The hover events may be performed with respect to a display screen of the display of the electronic device.

The hover events may be detected by identifying coordinates of at least one touch object that performs the hover events.

The coordinates of the at least one touch object may include x, y, and z coordinates.

The at least one touch object may include at least one of a finger of a user and a stylus.

The performing may include authenticating a user to permit the user to access the electronic device.

According to an aspect of another exemplary embodiment, there is provided a system for detecting a hover event, the system including: a hover detector configured to identify a number of hover events performed with respect to a display of an electronic device; and a hover event controller configured to perform at least one operation based on the identified number of hover events.

The hover event controller may be configured to estimate a height of a proximity touch with respect to the display of the electronic device, detect a local maximum and a local minimum for the proximity touch based on the estimated height, and determine the proximity touch as the hover event based on the detected local maximum and local minimum.

The system may further include a touch screen configured to detect a number of at least one touch object that performs the hover events based on an area of the touch screen, the area being covered by each of the at least one touch object. The hover detector may be configured to identify the number of the hover events based on the number of the at least one touch object. 14.

The tap event controller may include a comparator configured to determine a match between at least one of the hover events and pre-stored hover events; and an outputter configured to perform the at least one operation in response to determining the match.

The hover events may be performed with respect to a touch sensitive bezel of the display of the electronic device.

The hover events may be performed with respect to a display screen of the display of the electronic device.

The hover events may be detected by identifying coordinates of at least one touch object that performs the hover events.

The coordinates of the at least one touch object may include x, y, and z coordinates.

The at least one touch object may include at least one of a finger of a user and a stylus.

According to an aspect of still another exemplary embodiment, there is provided an apparatus for detecting a hover event including: a touch screen configured to detect a proximity touch input by a user and transmit information about a location of the proximity touch on the touch screen; a controller configured to estimate a height of the proximity touch and determine the proximity touch as the hover event based on a temporal change of the estimated height of the proximity touch; and a hover detector configured to detect a number of at least one touch object that performs the hover event based on detection of a size of the at least one touch object at the location of the proximity touch, wherein the controller is configured to perform at least one of authenticating the user and performing a particular operation based on at least one of a number of the detected hover event and the number of the at least one touch object.

### BRIEF DESCRIPTION OF THE DRAWINGS

The above and/or other aspects will become more apparent by describing certain exemplary embodiments with reference to the accompanying drawings, in which:

FIG. 1 is a block diagram of an electronic device including a capacitive touch screen, according to an exemplary embodiment;

FIG. 2 illustrates a detailed view of a tap event controller in FIG. 1, according to an exemplary embodiment;

FIG. 3 is a flowchart illustrating a method of performing an action based on a number of tap events in a hover state in an electronic device, according to an exemplary embodiment;

FIG. 4 is a graph representing a tap gesture in an electronic device, according to an exemplary embodiment.

FIG. 5 is a graph representing a smoothened tap gesture, according to an exemplary embodiment;

FIG. 6 is a schematic view illustrating a segmentation method to detect clustered and non-clustered fingers, according to exemplary embodiment;

FIG. 7 is a schematic view illustrating tapping events in a hover state, according to exemplary embodiments; and

FIG. 8 is block diagram of a computing system performing a method for detecting hover gestures in an electronic device, according to an exemplary embodiment.

### DETAILED DESCRIPTION

The exemplary embodiments herein and the various features and advantageous details thereof are explained more fully with reference to the non-limiting exemplary embodiments that are illustrated in the accompanying drawings and detailed in the following description. Descriptions of well-known components and processing techniques are omitted so as to not unnecessarily obscure the exemplary embodiments herein. Also, the various exemplary embodiments described herein are not necessarily mutually exclusive, as some exemplary embodiments may be combined with one or more other exemplary embodiments to form new exemplary embodiments. The term “or” as used herein, refers to a non-exclusive or, unless otherwise indicated. The examples used herein are intended merely to facilitate an understanding of ways in which the exemplary embodiments herein may be practiced and to further enable those of ordinary skill in the art to practice the exemplary embodiments herein. Accordingly, the examples should not be construed as limiting the scope of the exemplary embodiments herein.

The exemplary embodiments herein achieve a method and a system for performing one or more actions based on the number of tap events in a hover state. The method provides a set of tap gestures performed in a hover state in order to interact with an electronic device. The hover state refers to a state in which a touch object is not in physical contact with a display and within a distance from the display that may be recognized by the electronic device.

The method further provides mechanisms to detect the tap gestures in the hover state. The method includes authenticating a user of the electronic device based on proximity based tap gestures on capacitive based touch panels. The tap gestures are detected by observing a sequence of local maxima and local minima of proximity information. The proximity information may include coordinates of a height of a touch object or a value of energy (or sum of capacitance).

Tap gestures may include a tapping in a specific manner by one or more touch objects in the hover state above the electronic device. The specific manner may be pre-defined by the user of the electronic device during a training phase of the electronic device. For example, tapping three times by using various combinations of fingers leads to an action on the electronic device. According to exemplary embodiments herein, tapping in a specific manner in the hover state above the electronic device is referred to as a tap event. A gesture including the tap event performed by one or more touch objects is referred to as a tap gesture. The gestures are performed in the hover state. It is to be understood that while various exemplary embodiments are described with fingers as the touch object, the exemplary embodiments may be applied to any devices capable of perceiving or distinguishing a touch object in a hover state. For example, in an exemplary embodiment, the touch object may be a stylus pen. The touch object may not need to be carried by the user from place to place nor require a particular technology to operate. Examples of touch objects that may be recognized by the electronic device include hand(s), finger(s), dot on finger, and/or other items or objects. Virtually any object that may be detected by the electronic device may be utilized to invoke a menu, command or other action.

Throughout the specification, the terms “tap gesture” and “hover gesture” are used interchangeably. Further, the terms “touch panel” and “touch screen” are used interchangeably. Also, the terms “touch segment” and “segment” are used interchangeably.

Certain exemplary embodiments are described in greater detail below with reference to the accompanying drawings. In the following description, similar reference numerals are used to denote similar elements throughout the drawings.

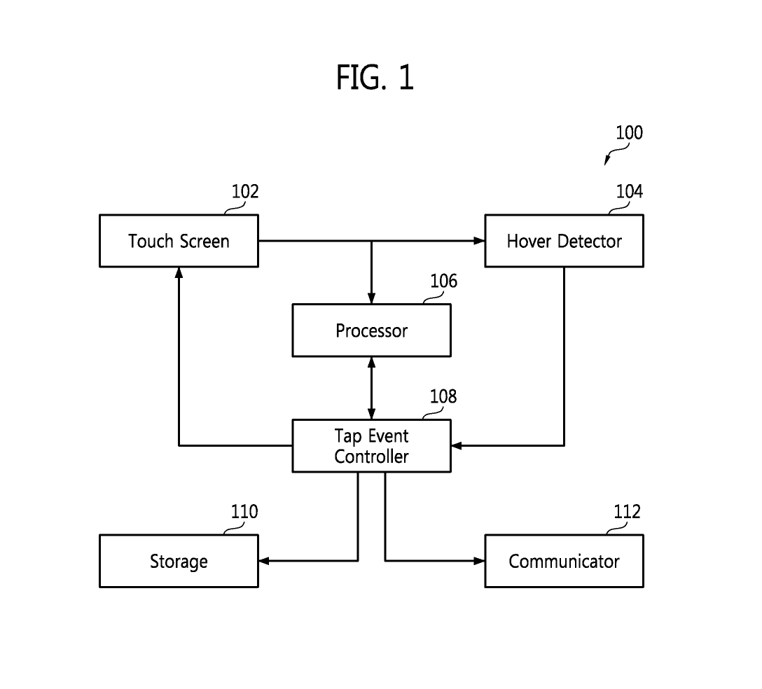

FIG. 1 is a block diagram of an electronic device 100 including a capacitive touch panel, according to an exemplary embodiment. The electronic device 100 may be a smart phone, a wearable device, a human-computer interaction device, a laptop, a tablet computer, a phablet and the like. The electronic device 100 includes a touch screen 102, a hover detector 104, a processor 106, a tap event controller 108, a storage 110, and a communicator 112.

The touch screen 102 outputs to the tap event controller 108 an input signal according to a proximity based touch of a user, receives a display signal from the tap event controller 108, and displays an image based on the display signal on a display area of the touch screen 102 in accordance with control of the tap event controller 108. The touch screen 102 further identifies a touch location of the proximity based touch of a touch object based on a difference in the capacitance. In an exemplary embodiment, a capacitive touch screen may be employed as the touch screen 102. The tap event controller 108 may detect a level of a difference in the capacitance which is varied according to a touch location on the capacitive touch panel, and determine that the input signal is generated at a touch point (or touch location) where the difference in the capacitance reaches a predetermined threshold level of capacitance. For example, when a touch object performs a hover interaction with respect to the touch screen 102, the touch screen 102 determines that there is a hover interaction performed by the user with respect to the electronic device 100 and transmits information about the determined hover interaction along with the touch location to the hover detector 104 and the processor 106. The hover interactions may include user interactions prior to contacting the touch screen 102 by the object and may be characterized by various parameters such as a distance, a velocity, an acceleration, and a three-dimensional (3D) position of the object (e.g., a hand or finger).

The touch screen 102 is further configured to detect a number of touch objects used to perform a number of tap events based on an area covered by each the number of touch objects (or a Phi size of each object).

According to an exemplary embodiment, the touch screen 102 may be provided based on various sensing technologies including, but not limited to, capacitive sensing, resistive sensing, surface acoustic wave sensing, pressure sensing, optical sensing, and/or the like. Furthermore, the touch screen 102 may be provided based on single point sensing or multipoint sensing. Single point sensing may be capable of distinguishing only a single touch, while multipoint sensing may be capable of distinguishing multiple touches in a hover state that occur at the same time.

A tap gesture may be pre-defined or defined by a user by associating a specific action or command to the tap gesture. A user-defined tap gesture may be used as a user password with added security measures or any other desired action or command.

The tap gesture may be created by a concurrent use of fingers and/or palms of one or both hands in a hover state. The start of a gesture may be determined based on at least one of a change in the capacitance value, the start of the user interaction in a pre-designated area of the touch panel, and the start of a specific system gesture that indicates the start of a multi-touch multi-shape gesture. Each of the tap gestures generally may have a particular sequence, motion, or orientation associated therewith. Such gestures are captured by the touch screen 102.

More than one user may interact with the display at substantially the same time. Each person may utilize a different touch object and a different portion of the display. The number of users that interact with the electronic device 100 may be as many as gestures that are in proximity to the electronic device 100 and which the electronic device 100 may recognize.

The hover detector 104 detects a tap event based on the hover interactions received from the touch screen 102. Each of the hover interactions includes an identified tap event with respect to the touch object, for example, a tap event involved with fingers that are moved separately or in a clustered manner in various directions outside or within a touch panel plane. The tap event comprises the tap gesture. That is, the tap event includes at least one tap characterized by an initial gradual finger approaching, followed by a duration of acceptable finger press at a certain height from the touch panel that is, in turn, followed by a gradual finger removal. Rules for a touch event may be further defined through experimentation to determine a reasonably constant signal stream pattern for a given gesture or interaction to be intended by a user. Further, the tap event may be performed by a stylus.

The tap events may be performed on the display screen of the electronic device 100 or on an area of a bezel of the electronic device 100. The bezel of the electronic device 100 refers to an area of the display surrounding the touch screen 102 and is capable of detecting a hover, i.e., the bezel area corresponds to a touch sensitive bezel area. Touch sensitive bezels may be used in a wearable device or a high end phone where bezels are also a touch screen, displaying various types of messages such as short message service (SMS) alerts, stock prices etc. Also, in an exemplary embodiment, a back panel and/or a side of a phone, which may not be included in a display of the phone, may also correspond to a touch sensitive area which may detect the hover gestures. Also the touch objects may include touch pads as those employed in laptops. The hover detector 104 sends information regarding an identified tap event to the tap event controller 108 upon analyzing the hover interactions performed by the user.

In an exemplary embodiment, the hover detector 104 may also detect the tap events based on infra-red rays, or through any other sensors known in the art.

The processor 106 may include any type of a computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuits. The processor 106 may also include embedded controllers, such as generic or programmable logic devices or arrays, application specific integrated circuits, single-chip computers, smart cards, and the like.

The tap event controller 108 controls an overall operation of the electronic device 100. The tap event controller 108 is configured to communicate with various modules of the electronic device 100 as described above. Hereinafter, an input method according to an exemplary embodiment in the tap event controller 108 will now be described in detail with reference to the drawings.

The storage 110 is configured to store user defined tap events and actions corresponding to the user defined tap events during a training phase of the electronic device 100. The storage 110 is also configured to store a lookup table mapping the tap events to corresponding actions to be performed when the tap events are detected. The storage 110 may include any suitable memory device for storing data and machine-readable instructions, such as a read only memory (ROM), a random access memory (RAM), an erasable programmable read only memory (EPROM), an electrically erasable programmable read only memory (EEPROM), a hard drive, a removable media drive for handling compact disks, a digital video disk, a diskette, a magnetic tape cartridge, a memory card, and the like.

The communicator 112 is configured to receive tap events in a hover state by a user of the electronic device 100 and perform wired or wireless communication under control of the tap event controller 108.

Exemplary embodiments of the present inventive concept may be implemented in conjunction with modules including functions, procedures, data structures, and application programs, for performing tasks, or defining abstract data types or low-level hardware contexts.

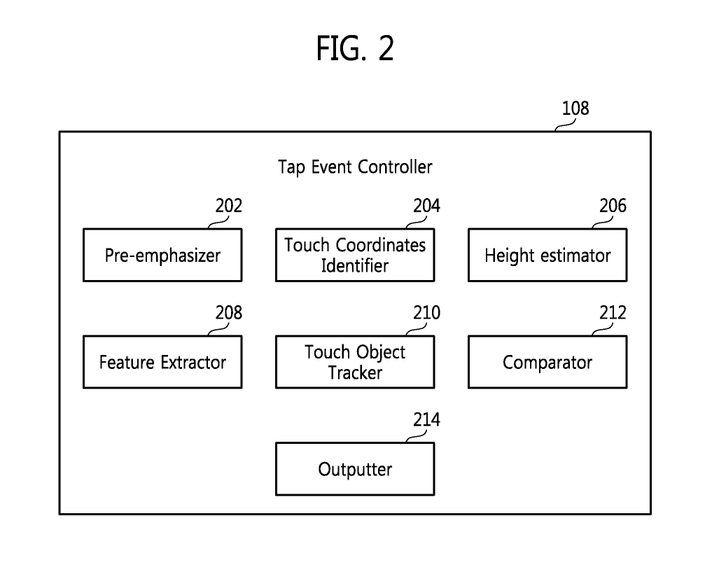

FIG. 2 illustrates a detailed view of a tap event controller 108 shown in FIG. 1, according to an exemplary embodiment. The tap event controller 108 comprises a pre-emphasizer 202, a touch coordinates identifier 204, a height estimator 206, a feature extractor 208, a touch object tracker 210, a comparator 212 and an outputter 214.

The pre-emphasizer 202 filters difference capacitance data corresponding to a touch location to improve a signal to noise ratio (SNR) using local filters such as moving average, moving median, or savitzky-golay to ensure a jitter is suppressed. The difference capacitance data corresponding to a touch location is obtained from the touch screen 102.

The touch coordinates identifier 204 computes x and y coordinates of a touch location using coordinate extraction methods known in the art. The x-coordinate corresponds to an X axis component of the touch location on the touch screen 102 and the y-coordinate corresponds to a Y axis component of the touch location on touch screen 102. When a touch object interacts with the electronic device 100, the touch screen 102 identifies the touch location of the interaction performed by the touch object and transmits the identified touch location to the pre-emphasizer 202 of the tap event controller 108. The pre-emphasizer 202 smoothens the difference capacitance data corresponding to the touch location and outputs smoothened difference capacitance data to the touch coordinates identifier 204. The touch coordinates identifier 204 computes the x and y coordinates of the touch location using the coordinate extraction methods known in the art such as 1-Phi or 2-Phi coordinate extraction methods which are based on interpolation, centroid calculation, and edge compensations.

The height estimator 206 is configured to estimate a height of each of the number of tap events in the hover state using location estimation methods known in the art. For example, the location estimation methods may be a 3D location estimation for the touch object in a proximity of capacitive touch panels. The 3D location estimation method involves extracting features such as energy, a gradient and so on using capacitance data, and by using the extracted features, estimating x and y coordinates and a height of touch object in a two stage based classifier-regressor approach. Further, the location estimation methods may include learning parameters for classifier based approaches such as a linear discriminant analysis (LDA) or Gaussian mixture models (GMM) and parameters for a transfer function based regression approach in a training phase. Furthermore, the location estimation methods may include classifying data collected in a given frame and applying corresponding regression parameters to estimate a continuous height during a testing phase.

A height coordinate (i.e., a z coordinate) is configured to differentiate between the touch object in contact with the display screen 102 and the touch object that is in a parallel proximity to the display screen 102 (e.g., in the hover state). In other words, the z coordinate corresponds to a height of the touch object above the touch panel. The parallel proximity may include a very close proximity to the touch screen 102 to a predetermined distance away from the touch screen 102. For example, in small sized displays, such as a table personal computer (PC), a maximum distance between the touch object and the touch screen 102 to be detected as the parallel proximity may be about one inch. If the touch object is in a state between an actual contact with the touch screen 102 and about an inch away from the touch screen 102, the touch object may be in the hover state. In larger sized displays, such as a wall-sized display, the hover state may be in a range from touching the display screen 102 to a foot or more away from the display screen 102. It is to be understood that the above described distances are for illustration purposes only and other distances may be utilized and fall within the scope of the systems, methods and/or devices according to exemplary embodiments.

The feature extractor 208 extracts features associated with the touch object upon computing the height of the touch object and x and y coordinates of the touch object. The feature extractor 208 is further configured to compute a local maxima and a local minima for each of the number of tap events based on the estimated height. The process of feature extraction is carried out during a training phase and a testing phase, for example, in real-time. In case of tap gesture detection, the extracted height coordinates of the touch object or a sum of capacitances (or energy) are used for detecting the tap event.

The hover detector 104 may detect a given segment as one of the following, but not limited to:

i) Thumb;

ii) Single finger (one of ring, middle, and index fingers);

iii) Little finger;

iv) Two fingers (e.g., ring and middle fingers, or middle and index fingers); and

v) Three fingers (e.g., middle, ring, and index fingers).

A segment (or touch segment) is an isolated touch object on the touch screen 102. A segmentation algorithm performed by the hover detector 104 may identify different touch segments on the touch screen 102. The touch segment is a contour formed by touch object on the touch screen 102. Segmentation methods such as thresholding, histogram based, region growing, and water shed algorithms may be performed on a touch frame to identify and classify different segments. The identified segments are compared with stored segment patterns to identify if the segment is a thumb or a palm, or two fingers (e.g., ring and middle fingers, or middle and index fingers), or three fingers (middle, ring, index fingers) and so on.

Further, the hover detector 104 detects the given segment by extracting features such as an area, a shape, an aspect ratio, a circularity, etc. The extracted features may be trained using a supervised model (e.g., discriminant analysis, support vector machines, decision trees, or a simple Euclidean distance based classifier) for providing training data set and the extracted decision boundary (a classifier hypothesis) may be used to classify a given segment online.

Similarly, a simultaneous motion of the segments may be easily detected by using tracking algorithms to track the motion of the touch object. General distance and intensity based region growing algorithms may be used for performing segmentation.

A password entry may be considered as being in a simultaneous mode if a number of taps by each of segments for which a simultaneous motion is detected is the same. Accordingly, it is ensured that tap events by the segments are performed synchronously. Otherwise, a single segment having a largest number of taps may be considered as the password entry.

The touch object tracker 210 is configured to track multiple touch objects within a single frame by labeling each touch segment based on previous touch segments to link appropriate touch segments over the time. This is performed by using simple distance based or Kalman filter based methods. A single frame refers to scan data comprising capacitance values from top to bottom of touch screen 102. The single frame may be obtained at a rate of, for example, 50 Hz. Hence, 50 frames per second are obtained. One frame represents capacitance values of all nodes of touch screen 102 in a matrix form.

The comparator 212 is configured to determine a match between at least one tap event in the hover state and a corresponding stored tap event. The comparator 212 compares a feature corresponding to the at least one tap event with a pre-stored feature of one or more tap events. If the feature corresponding to the at least one tap event matches with the pre-stored feature of at least one tap event, the comparator 212 determines that the at least one tap event matches with one of the stored tap events. The comparator 212 outputs a result of the comparison to the outputter 214. The comparator 212 is further configured to authenticate the user to perform at least one operation in the electronic device 100. In an exemplary embodiment, once the local maxima and the local minima for the at least one tap event are extracted by the feature extractor 208, a repeated sequence of maximum-minimum-maximum is compared with a pre-stored sequence of maximum-minimum-maximum and a number of matches therebetween is used to identify the tap gesture and the number of touch segments involved in the identified tap gesture. The above maximum-minimum-maximum pattern may be valid if height coordinates are used in tap detection. In an exemplary embodiment, if energy (or sum of capacitance values) is used as the input to tap detection, a minimum-maximum-minimum pattern is matched for identifying the appropriate tap event.

Similarly, the pattern of maximum-minimum is matched against a previously stored sequence of maximum-minimum.

The outputter 214 is configured to perform at least one action based on the identified number of tap events. When the comparison result is received from the comparator 212, the outputter 214 determines whether the comparison result indicates that the at least one tap event in the hover state performed by the user matches with one of the stored tap event. If yes, the outputter 214 obtains the one or more actions to be performed corresponding to the matched tap event from a look up table and triggers the one or more actions in the electronic device 100.

When a tap event is detected in a hover state, the touch screen 102 identifies the touch location of the touch object performing the tap event. In an exemplary embodiment, the touch location is a centroid value (x, y) of the touch object or touch segment. The touch screen 102 transmits the touch location information of the touch object to the hover detector 104 and the processor 106. The hover detector 104 identifies the touch segment involved in the tap event based on the identified touch location of the touch object. Further, the hover detector 104 identifies the tap event associated with the identified touch segment based on a set of parameters.

The tap event comprises at least one of simultaneously tapping a number of times by at least one touch object; tapping a number of times by at least one touch object; tapping a number of times by clustering at least one finger of the user; and tapping a number of times by at least one individual finger of the user. The set of parameters comprises a number of taps, a number of clustered fingers, a mode of taps (e.g., simultaneous or sequential), and a shape of the touch object, which will be explained in detail below. The set of parameters may include additional values or parameters that are well known to a person of ordinary skill in the art.

Upon identifying a tap event, the hover detector 104 transmits information about the identified tap event to the processor 106. The processor 106 analyzes the touch location obtained from the touch screen 102 and the tap event obtained from the hover detector 104 and forwards the touch location and the tap gesture event to the tap event controller 108. The tap event controller 108 smoothens the capacitance data associated with the touch location and computes the touch coordinates. The tap event controller 108 also computes the height coordinates of the touch object based on temporal information of a 3D location of each touch object.

Upon computing the touch coordinates and the height coordinates of the touch object, the tap event controller 108 extracts one or more features associated with the touch object to identify the tap gesture associated with the tap event. Further, the tap event controller 108 tracks the one or more touch objects to identify the movements of the touch segment and hence generate a graph of a temporal change of the 3D touch location of the touch object with respect to the height of the touch object. Based on the generated graph, the tap event controller 108 identifies the tap gesture associated with the tap event and compares the tap event with stored one or more tap events. If the tap event controller 108 determines that the tap event matches with the stored tap event, the tap event controller 108 retrieves the one or more actions to be performed from a lookup table when the matched tap event is detected and performs the retrieved one or more actions corresponding to the tap event performed by the user.

In an exemplary embodiment, the touch objects may be human fingers. In general, a tap event may comprise tapping a number of times by one or more fingers in a specified manner. Tapping a number of times by one or more fingers in a specified manner may include a simple tap, a distinctive tap gesture formed by clustering a plurality of fingers, e.g., two fingers, three fingers, or four fingers and tapping on a hover supported touch screen device. In case of the distinctive tap gesture formed by the clustered fingers, it should be noted that the size (e.g., a Phi size) of the area of the touch object changes and hence an increase of the area of contact with touch screen 102 may result in a more change in a capacitance value. Hence, the electronic device 100 including a self-capacitance based touch screen is capable of distinguishing between each tap—one finger tapping or two finger tapping or three or four finger tapping. Hence, each distinctive tap gesture may be used in an authentication method or may be used as a different gesture to trigger a different action in the electronic device 100 having the hover supported touch screen.

In an exemplary embodiment, the taps (e.g., an N number of times of taps) may also include tapping simultaneously or sequentially by un-clustered fingers (e.g., two or three fingers). In this case, in a multi-hover supporting touch device, a number of touch segments may be equal to a number of touch objects (e.g., fingers) and hence, the multi-hover supporting touch device extracts and identifies simultaneous taps by a plurality of fingers (e.g., two, three, or four fingers). Each distinctive simultaneous tap is identified as a different tap gesture. Taps (e.g., an N number of times of taps) may include taps by clustered fingers which may be used for authentication purposes, distinctive tap gestures by clustered fingers, and/or a combination thereof. In an exemplary embodiment, there may exist a various types of tap gestures including a plurality of combinations of a number of taps and clustering touch objects (e.g., fingers). For example, tapping two times by two fingers joined (or clustered) together is different from tapping two times by three fingers clustered together because of a different Phi size of the touch object, which is detected by the hover detector 104.

Each distinctive tap combination may be determined as a different tap gesture or may be used for an authentication purpose. In another exemplary embodiment, taps (e.g., an N number of times of taps) may include a combination of N number of simultaneous finger taps which may be used for authentication and distinctive taps by non-clustered fingers that are input simultaneously or sequentially. For example, tapping two times by two fingers that are separated (or non-clustered) is different from tapping two times by three fingers that are non-clustered because of a difference between three segments in the latter case compared to two segments in the former case, which is detected by the hover detector 104. Each distinctive tap combination may be determined as a different tap gesture or may be used for authentication.

In an exemplary embodiment, the hover detector 104 detects the tap gesture based on the hover, a number of taps, a shape of the touch object, and a mode of the tap gesture. In an exemplary embodiment, a combination of a number of taps (N's), clustered fingers (C's), simultaneous tap mode (P's) may be used to enhance security of the electronic device 100. For example, if entries of all N's+C's+P's are correct, the user may obtain an access to the electronic device 100 as a supervisor and/or administrator.

If entries of only N's+C's are correct, the user may obtain a limited access to the electronic device 100 such as, for example, for a special user so that some of applications and/or settings are inaccessible.

If entries of only N's are correct, the user may obtain a very basic limited access to the electronic device 100 such as for a kid such that a different user interface (UI) and only a few accessible applications are provided.

In this manner, a user may share the user's electronic device 100 with another user without revealing all information and/or access to the electronic device 100.

In an exemplary embodiment, a human thumb may also be used as an anchor position in detecting the taps. A thumb may indicate the direction of taps (e.g., from left to right or right to left). The hover detector 102 may detect the thumb by segmentation when the thumb is disposed parallel to the touch screen 102 and is elongated while other fingers are used to perform taps. The tap event controller 108 may use the detected thumb and easily track taps. Unlike other existing methods, the exemplary embodiments are not restricted to a particular area of the touch screen and the electronic device 100 does not prompt for authentication, and hence the user needs to know how to perform authentication for the electronic device 100, such as a password, a pattern, or a taps.

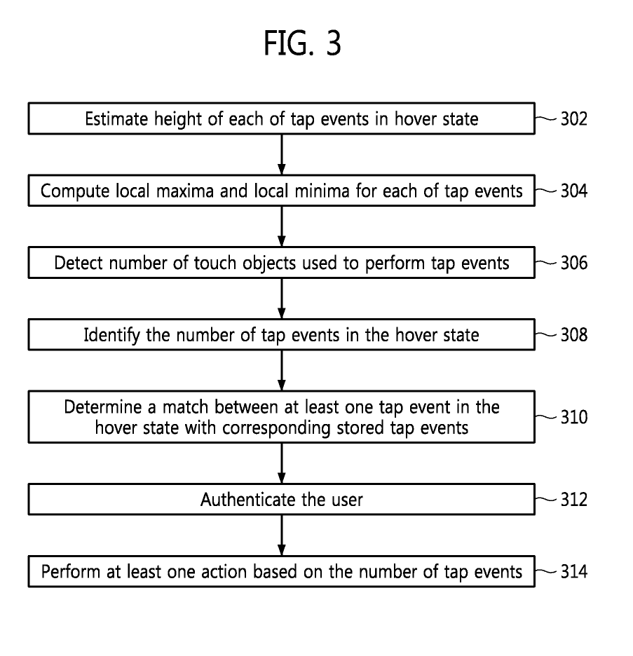

FIG. 3 is a flowchart illustrating a method of performing an action based on a number of tap events in a hover state in the electronic device 100, according to an exemplary embodiment. At step 302, a height of each of the number of tap events in a hover state is estimated using location estimation methods known in the art. At step 304, a local maxima and a local minima are computed for each of the number of tap events based on the estimated height by the feature extractor 208.

At step 306, a number of touch objects used to perform the number of tap events are detected by the touch screen 102 based on an area covered by each of the number of touch objects (or a Phi size of each touch object).

At step 308, the number of tap events in the hover state performed on the display area of the electronic device 100 are identified by the hover detector 104 based on the number of touch objects.

At step 310, a match between at least one tap event in the hover state with stored tap events is determined by the comparator 212 of the tap event controller 108. If the tap event matches with the stored tap events, at step 312, the user is authenticated to perform at least one operation in the electronic device 100. If the tap event does not match with the corresponding stored tap events, the user is denied an access to the electronic device 100.

At step 314, at least one action is performed by the outputter 214 on the touch screen 102 based on the number of tap events.

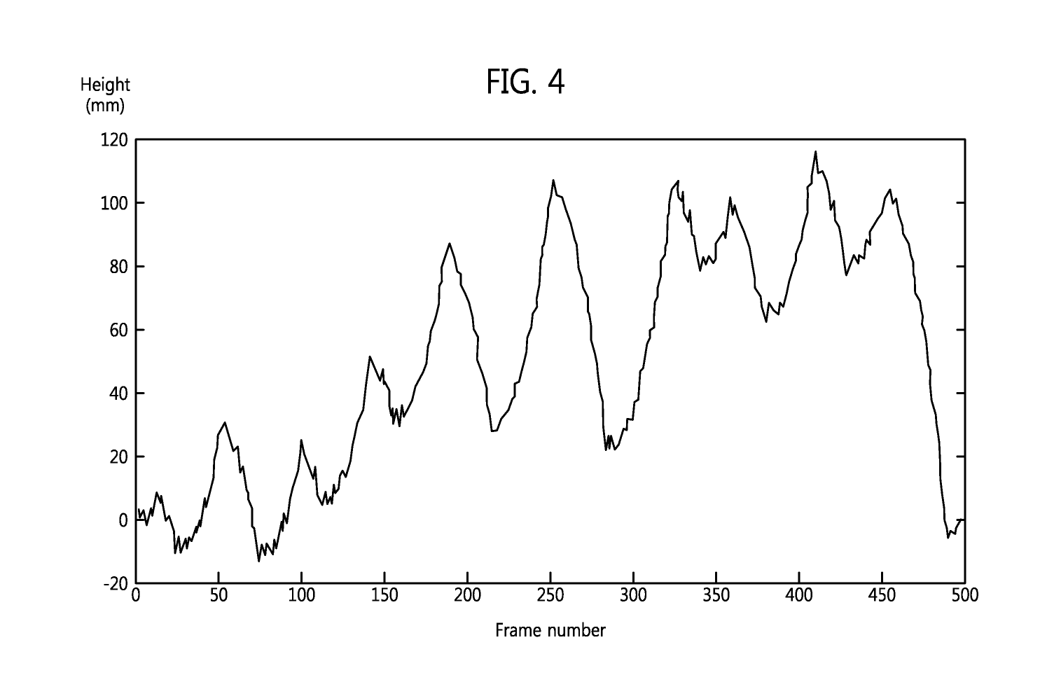

FIG. 4 is a graph representing a tap gesture in the electronic device 100, according to an exemplary embodiment. The graph as shown in FIG. 4 represents a temporal change in proximity data corresponding to a tap gesture (or a hover gesture) by measuring a height of the proximity data with respect to time (e.g., a frame number). Based on the graphical representation of the tap gesture as shown in FIG. 4, the processor 104 may analyze the touch location and tap event information.

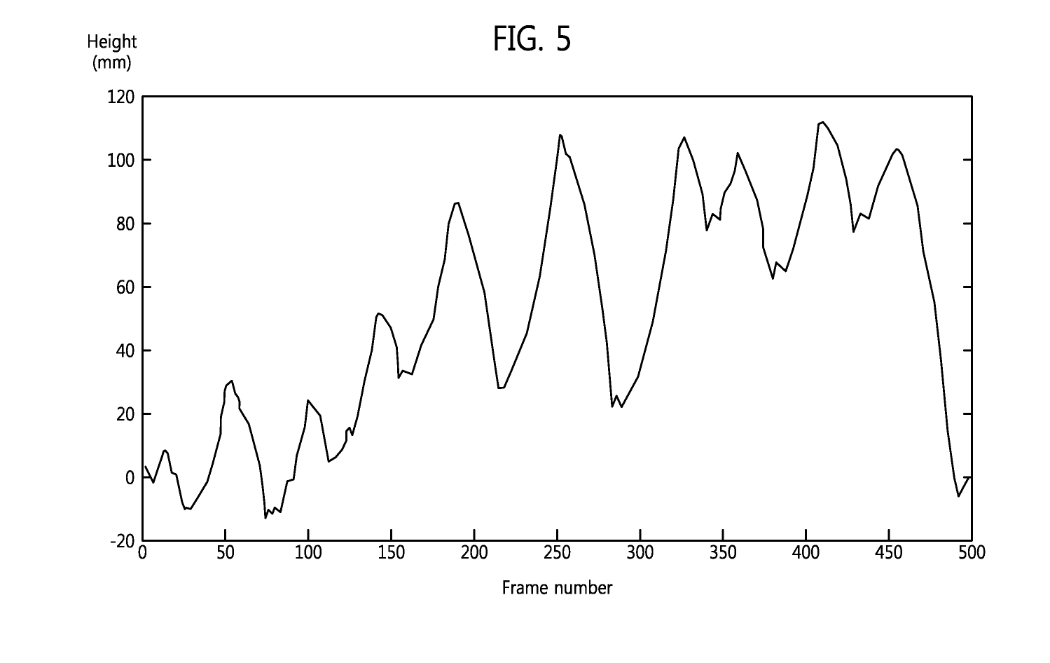

FIG. 5 is a graph representing a smoothened tap gesture, according to an exemplary embodiment. Here, the touch coordinates are smoothened using local filters such as moving average, moving median, or savitzky-golay to ensure a jitter is suppressed. The graphical representation in FIG. 5 may be obtained by the pre-emphasizer 202 of the tap event controller 108.

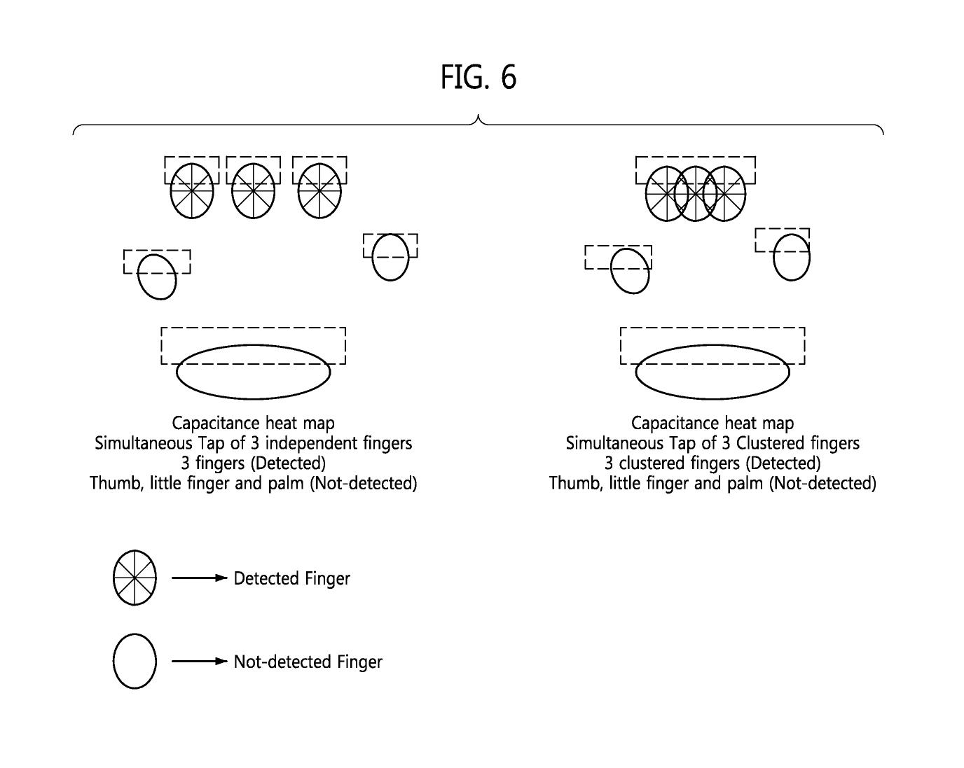

FIG. 6 is a schematic view illustrating a segmentation method to detect clustered and non-clustered fingers, according to exemplary embodiments. The segmentation methods such as thresholding, histogram based, region growing, and water shed algorithms may be performed on a touch frame to identify and classify different touch segments such as clustered or non-clustered fingers and so on.

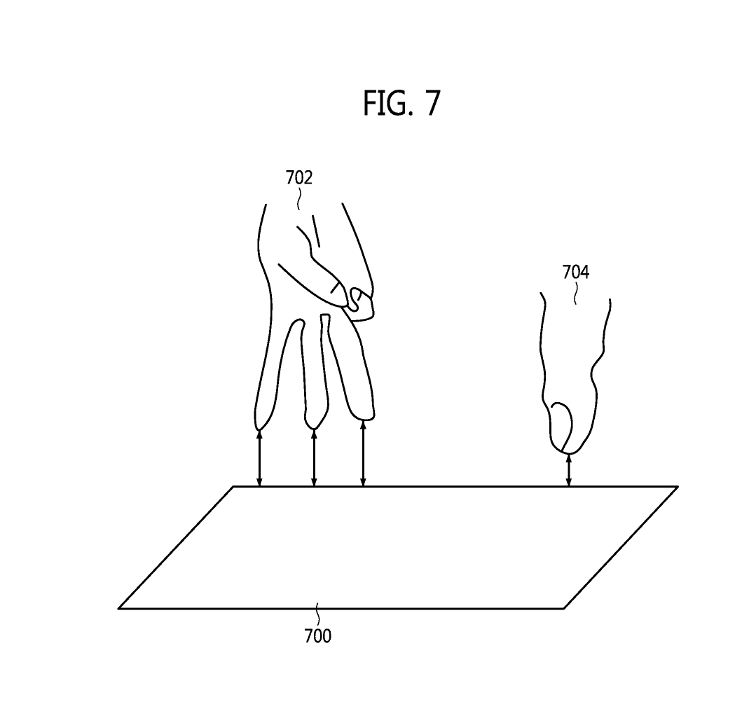

FIG. 7 is a schematic view illustrating tapping gestures, according to exemplary embodiments. FIG. 7 represents two types of tap gestures on a touch panel 700. A first type of a tap gesture 702 is formed by three un-clustered fingers tapping simultaneously in a hover state on the touch panel 700. When the user performs the tap gesture 702, the electronic device 100 identifies the tap event as three simultaneous taps by three fingers in a separated form and performs an action corresponding to the identified tap event on the electronic device 100. A second type of a tap gesture 704 is formed by tapping three times by a single finger on the touch panel 700. When the user performs the tap gesture 704, the electronic device 100 identifies the tap event as three simultaneous taps by the single finger and performs an action corresponding to the identified tap event on the electronic device 100.

It may be understood by a person of ordinary skill in the art that the type of tap gestures are not limited to the examples explained above. The type of tap gestures may include, for example, tapping any number of times by any combination of fingers in a clustered or separated form performed simultaneously or in sequence. Prior to performing the tap gesture, the user may need to pre-define the types of gestures and the corresponding action to be performed on the electronic device 100.

According to an exemplary embodiment, the tap with three combined and/or clustered fingers may trigger an emergency dial while the electronic device 100 is in a lock state. Further, the taps may set a phone to a silent and/or do-not-disturb (DND) mode with a one-step touch gesture. Non-clustered finger taps may trigger simultaneous opening of a plurality (e.g., three) of images, videos, or applications and display the opened images, videos, or applications in different sections and/or windows of the touch screen 700. Also, the taps may be used to close an application. The above examples may be used for authentication methods, while it is to be understood by a person of ordinary skill in the art that these tap gestures are not limited for authentication purposes and are applicable for any other applications known in the art.

In authentication methods, taps are useful in highly secure automatic teller machines (ATMs), where the user does not need to leave a trace of the user's password to avoid a smudge attack. Further, taps are useful in rugged areas such as construction sites or an agricultural area and also in domestic environments such as, for example, a kitchen. Unlike other methods, taps need not be restricted to a particular area of the touch screen 700.

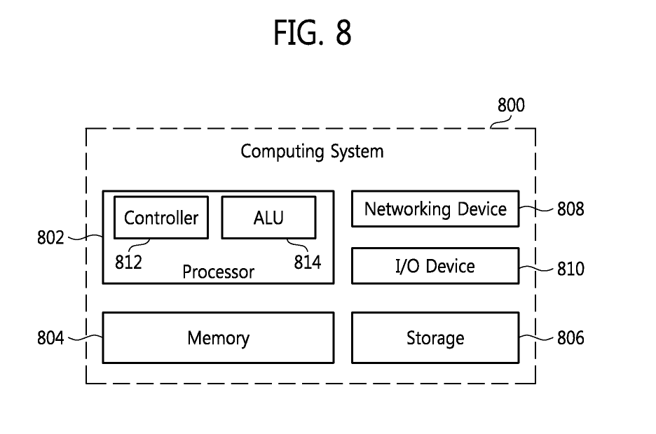

FIG. 8 is block diagram of a computing system 800 for performing a method for detecting hover gestures in the electronic device 100, according to an exemplary embodiment. As depicted in the FIG. 8, the computing system 800 comprises at least one processor 802 that is equipped with a controller 812 and an arithmetic logic unit (ALU) 814, a memory 804, a storage 806, a networking device 808 and an input and/or output (I/O) device 810. In an exemplary embodiment, the networking device 808 and the I/O device 810 may include a plurality of networking devices 808 and a plurality of I/O devices, respectively.

The processor 802 may process instructions of an algorithm of the computing system 800. The processor 802 receives commands from the controller 812 to perform the processing of the instructions. Further, any logical and arithmetic operations involved in execution of the instructions may be computed by the ALU 814. The algorithm comprising instructions and codes for the implementation of the hover gestures may be stored in the memory 804 or the storage 1606 or both. The instructions may be fetched from the memory 804 and/or storage 806, and executed by the processor 802. The processor 802 includes any type of a computational circuit such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuits. The processor 802 may also include embedded controllers, such as generic or programmable logic devices or arrays, application specific integrated circuits, single-chip computers, smart cards, and the like.

The memory 804 may include a volatile memory and/or a non-volatile memory. A variety of computer-readable storage media may store and access the memory 804. The memory 804 may include any suitable memory device(s) for storing data and machine-readable instructions, such as a read only memory, a random access memory, an erasable programmable read only memory, an electrically erasable programmable read only memory, a hard drive, a removable media drive for handling compact disks, a digital video disk, a diskette, a magnetic tape cartridge, a memory card, and the like.

Exemplary embodiments may be implemented in conjunction with modules, including functions, procedures, data structures, and application programs, for performing tasks, or defining abstract data types or low-level hardware contexts. The tap event controller 108 may be stored in the form of machine-readable instructions on any of the above-mentioned storage media and may be executed by the processor 802. For example, a computer program may include machine-readable instructions that, when executed by the processor 802, cause the processor 802 to identify a number of tap events in a hover state performed on a display area of the electronic device 100 and perform at least one action based on the number of tap events, according to the exemplary embodiments. In one exemplary embodiment, the computer program may be included on a compact disk-read only memory (CD-ROM) and loaded from the CD-ROM to a hard drive in the non-volatile memory.

In case of any hardware implementations of the exemplary embodiments, various types of the networking devices 808 and/or the external I/O devices 810 may be included in the computing system 800 to support the implementation through the networking devices 808 and the I/O devices 810.

The exemplary embodiments may be implemented through at least one software program running on at least one hardware device and performing network management functions to control the elements. The elements shown in FIGS. 1, 2 and 8 include blocks which may be at least one of a hardware device, or a combination of hardware device and software module.

The described-above exemplary embodiments and advantages are merely exemplary and are not to be construed as limiting. The present teaching can be readily applied to other types of apparatuses. The description of exemplary embodiments is intended to be illustrative, and not to limit the scope of the claims, and many alternatives, modifications, and variations will be apparent to those skilled in the art.

What is claimed is:

1. A method of detecting a hover event in an electronic device, the method comprising:
identifying a number of hover events performed with respect to a display of the electronic device; and
performing at least one operation based on the identified number of the hover events.

2. The method of claim 1, wherein the identifying comprises:
estimating a height of a proximity touch with respect to the display of the electronic device;
detecting a local maximum and a local minimum for the proximity touch based on the estimated height; and
determining the proximity touch as the hover event based on the detected local maximum and local minimum.

3. The method of claim 1, wherein the identifying comprises:
detecting a number of at least one touch object that performs the hover events based on an area of the display, the area being covered by each of the at least one touch object; and
identifying the number of the hover events based on the number of the at least one touch object.

4. The method of claim 1, wherein the performing comprises:
determining a match between at least one of the hover events and pre-stored hover events; and
performing the at least one operation in response to determining the match.

5. The method of claim 1, wherein the hover events are performed with respect to a touch sensitive bezel of the display of the electronic device.

6. The method of claim 1, wherein the hover events are performed with respect to a display screen of the display of the electronic device.

7. The method of claim 1, wherein the hover events are detected by identifying coordinates of at least one touch object that performs the hover events.

8. The method of claim 7, wherein the coordinates of the at least one touch object comprises x, y, and z coordinates.

9. The method of claim 3, wherein the at least one touch object comprises at least one of a finger of a user and a stylus.

10. The method of claim 1, wherein the performing comprises:
authenticating a user to permit the user to access the electronic device.

11. A system for detecting a hover event, the system comprising:
a hover detector configured to identify a number of hover events performed with respect to a display of an electronic device; and
a hover event controller configured to perform at least one operation based on the identified number of hover events.

12. The system of claim 11, wherein the hover event controller is configured to estimate a height of a proximity touch with respect to the display of the electronic device, detect a local maximum and a local minimum for the proximity touch based on the estimated height, and determine the proximity touch as the hover event based on the detected local maximum and local minimum.

13. The system of claim 11, further comprising:
a touch screen configured to detect a number of at least one touch object that performs the hover events based on an area of the touch screen, the area being covered by each of the at least one touch object,
wherein the hover detector is configured to identify the number of the hover events based on the number of the at least one touch object.

14. The system of claim 11, wherein the tap event controller comprises:
a comparator configured to determine a match between at least one of the hover events and pre-stored hover events; and
an outputter configured to perform the at least one operation in response to determining the match.

15. The system of claim 11, wherein the hover events are performed with respect to a touch sensitive bezel of the display of the electronic device.

16. The system of claim 11, wherein the hover events are performed with respect to a display screen of the display of the electronic device.

17. The system of claim 11, wherein the hover events are detected by identifying coordinates of at least one touch object that performs the hover events.

18. The system of claim 11, wherein the coordinates of the at least one touch object comprises x, y, and z coordinates.

19. The system of claim 11, wherein the at least one touch object comprises at least one of a finger of a user and a stylus.

20. An apparatus for detecting a hover event, the apparatus comprising:
a touch screen configured to detect a proximity touch input by a user and transmit information about a location of the proximity touch on the touch screen;
a controller configured to estimate a height of the proximity touch and determine the proximity touch as the hover event based on a temporal change of the estimated height of the proximity touch; and
a hover detector configured to detect a number of at least one touch object that performs the hover event based on detection of a size of the at least one touch object at the location of the proximity touch,
wherein the controller is configured to perform at least one of authenticating the user and performing a particular operation based on at least one of a number of the detected hover event and the number of the at least one touch object.
